(19) United States
(12) Patent Application Publication
(10) Pub. No.: US 2026/0369006 A1
(43) Pub. Date: Nov. 19, 2026

(54) Selecting Multiple Virtual Objects

(71) Applicant: Apple Inc., Cupertino, CA (US)

(72) Inventors: Jordan A. Cazamias, San Francisco, CA (US); Aaron M. Burns, Sunnyvale, CA (US); David M. Schattel, Santa Clara, CA (US); Jonathan Perron, Felton, CA (US); Jonathan Ravasz, Sunnyvale, CA (US); Shih-Sang Chiu, Menlo Park, CA (US)

(21) Appl. No.: 19/751,619

(22) Filed: Jul. 23, 2026

Related U.S. Application Data
(63) Continuation of application No. 18/123,841, filed on Mar. 20, 2023, now abandoned.
Application No. 18/123,841 is a continuation of application No. PCT/US2021/047983, filed on Aug. 27, 2021.
(60) Provisional application No. 63/081,992, filed on Sep. 23, 2020.

(51) Int. Cl. G06T 17/00; G06F 3/01; G06T 7/20

(52) U.S. Cl. CPC G06T 17/00; G06F 3/017; G06T 7/20

(57) ABSTRACT

Various implementations disclosed herein include devices, systems, and methods for selecting multiple virtual objects within an environment. In some implementations, a method includes receiving a first gesture associated with a first virtual object in an environment. A movement of the first virtual object in the environment within a threshold distance of a second virtual object in the environment is detected. In response to detecting the movement of the first virtual object in the environment within the threshold distance of the second virtual object in the environment, a concurrent movement of the first virtual object and the second virtual object is displayed in the environment based on the first gesture.

### CROSS-REFERENCE TO RELATED APPLICATIONS

This application is a continuation of U.S. Patent App. No. 18/123,841, filed on Mar. 20, 2023, which is a continuation of Intl. Patent App. No. PCT/US2021/47983, filed on Aug. 27, 2021, which claims priority to U.S. Provisional Patent App. No. 63/081,992, filed on Sep. 23, 2020, which are all incorporated by reference in their entirety.

### TECHNICAL FIELD

The present disclosure generally relates to selecting virtual objects.

### BACKGROUND

Some devices are capable of generating and presenting graphical environments that include virtual objects and/or representations of physical elements. These environments may be presented on mobile communication devices.

### SUMMARY

Various implementations disclosed herein include devices, systems, and methods for selecting multiple virtual objects within an extended reality (XR) environment. In some implementations, a method includes receiving a first gesture associated with a first virtual object in an extended reality (XR) environment. A movement of the first virtual object in the XR environment within a threshold distance of a second virtual object in the XR environment is detected. In response to detecting the movement of the first virtual object in the XR environment within the threshold distance of the second virtual object in the XR environment, a concurrent movement of the first virtual object and the second virtual object is displayed in the XR environment based on the first gesture.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1H illustrate example operating environments according to some implementations.

FIG. 2 depicts an exemplary system for use in various computer enhanced technologies.

FIG. 3 is a block diagram of an example virtual object renderer according to some implementations.

FIGS. 4A-4C are flowchart representations of a method for selecting multiple virtual objects within an extended reality (XR) environment in accordance with some implementations.

FIG. 5 is a block diagram of a device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person’s physical motions, or representations thereof, can be tracked and, in response, characteristics of virtual objects simulated in the XR environment can be adjusted in a manner that complies with at least one law of physics. For instance, the XR system can detect the movement of a user’s head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users’ eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user’s eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users’ retinas. Projection systems can also project virtual objects into the physical environment (e.g., as a hologram or onto a physical surface).

In some implementations, an electronic device comprises one or more processors working with non-transitory memory. In some implementations, the non-transitory memory stores one or more programs of executable instructions that are executed by the one or more processors. In some implementations, the executable instructions carry out the techniques and processes described herein. In some implementations, a computer (readable) storage medium has instructions that, when executed by one or more processors of an electronic device, cause the electronic device to perform, or cause performance, of any of the techniques and processes described herein. The computer (readable) storage medium is non-transitory. In some implementations, a device includes one or more processors, a non-transitory memory, and means for performing or causing performance of the techniques and processes described herein.

The present disclosure provides methods, systems, and/or devices for selecting multiple virtual objects within an extended reality (XR) environment. In various implementations, an electronic device, such as a smartphone, tablet, or laptop or desktop computer, displays virtual objects in an extended reality (XR) environment.

Selection of multiple virtual objects in an XR environment can be tedious due to the effort involved in manipulating multiple virtual objects with gestures. For example, a user may create a group of virtual objects by moving a first virtual object to an area, then moving a second virtual object to the same area. The user may repeat the process to add other virtual objects to the group. Using these gestures to organize virtual objects in the XR environment may involve large gestures performed by the user. Requiring a user to arrange the virtual objects by using a large gesture for each virtual object may increase the amount of effort the user expends to organize the virtual objects. Interpreting and acting upon user inputs that correspond to the user manually arranging the virtual objects results in power consumption and/or heat generation, thereby adversely impacting operability of the device.

In various implementations, a user can use a gesture to select a first virtual object and to initiate the selection of multiple virtual objects. The user can then use the first virtual object as a tool to select other virtual objects by passing over them. As the user passes over the other virtual objects, the virtual objects are moved together, e.g., as a group. When the user performs another gesture, the virtual objects are dropped together. The user can thus select and move multiple virtual objects using a simplified set of movements. For example, the user may avoid the need for separate gestures to select multiple virtual objects to add to a group of virtual objects. In some implementations, a single gesture may be used to create a group of virtual objects. Reducing unnecessary user inputs reduces utilization of computing resources associated with interpreting and acting upon unnecessary user inputs, thereby enhancing operability of the device by reducing power consumption and/or heat generation by the device.

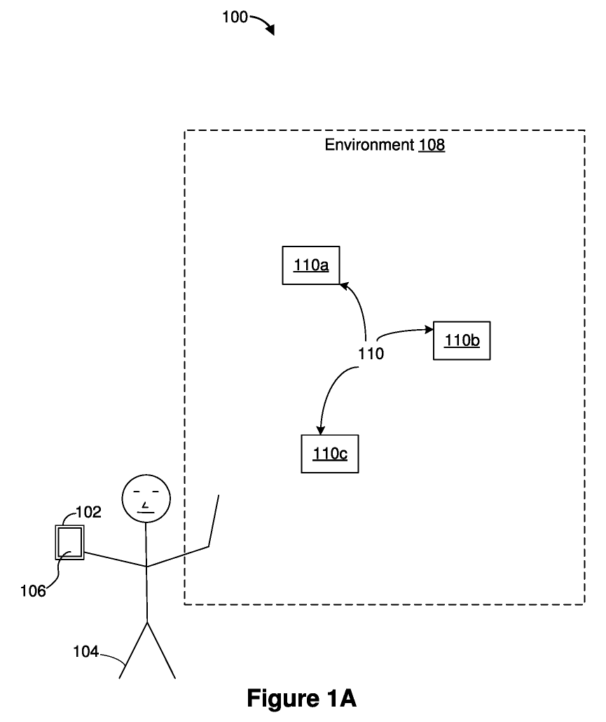

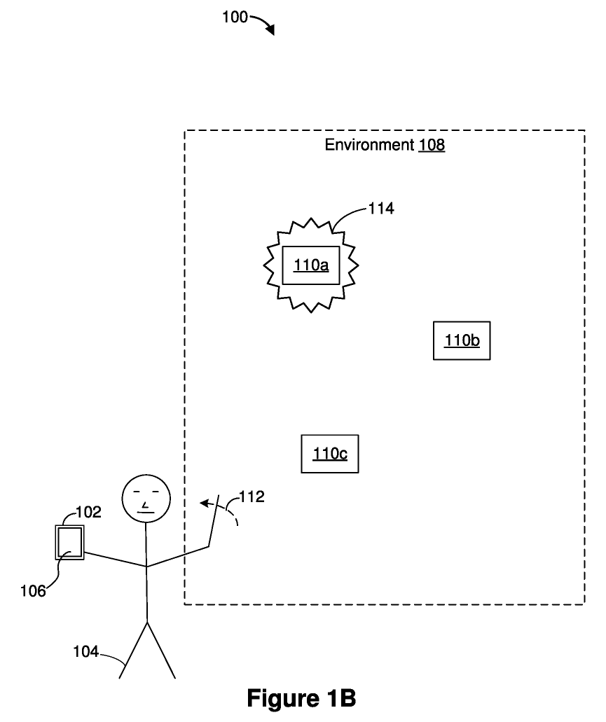

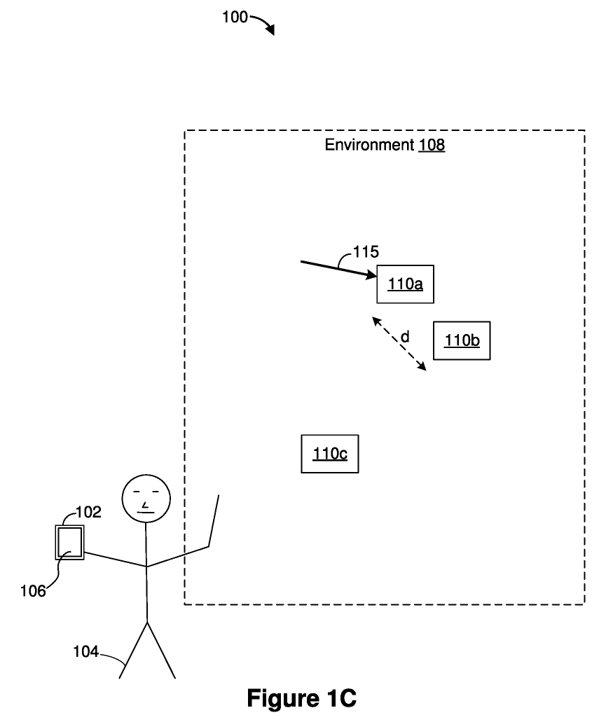

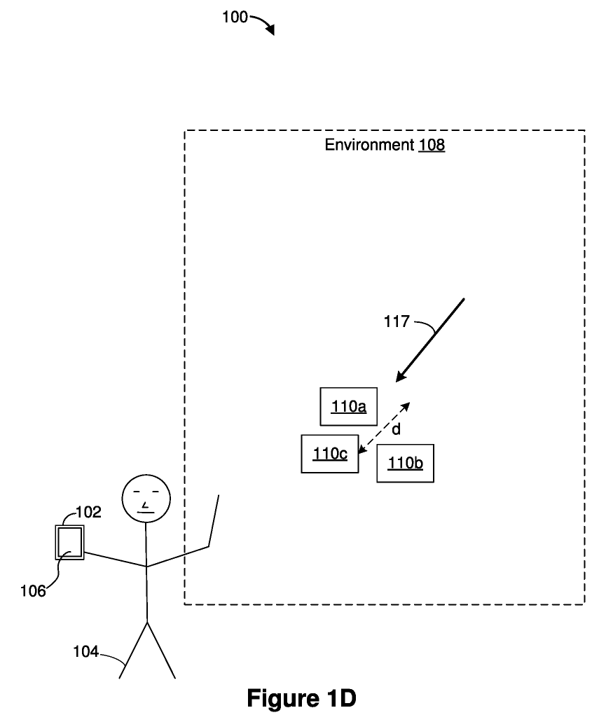

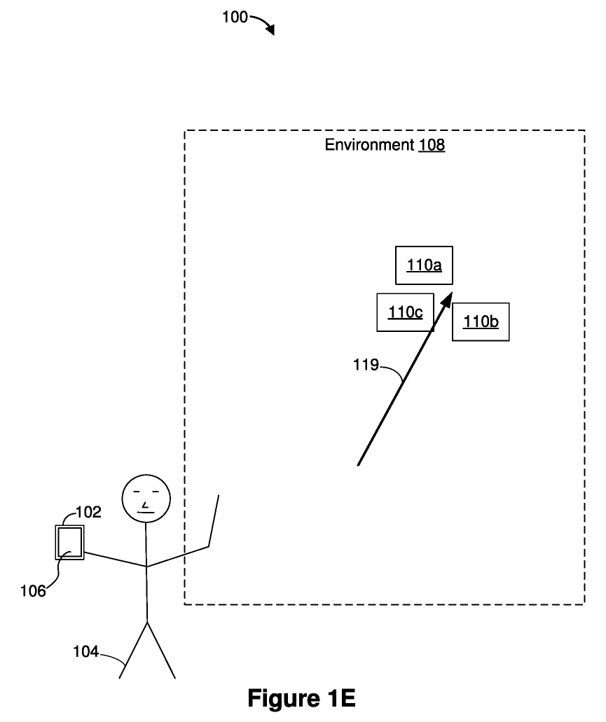

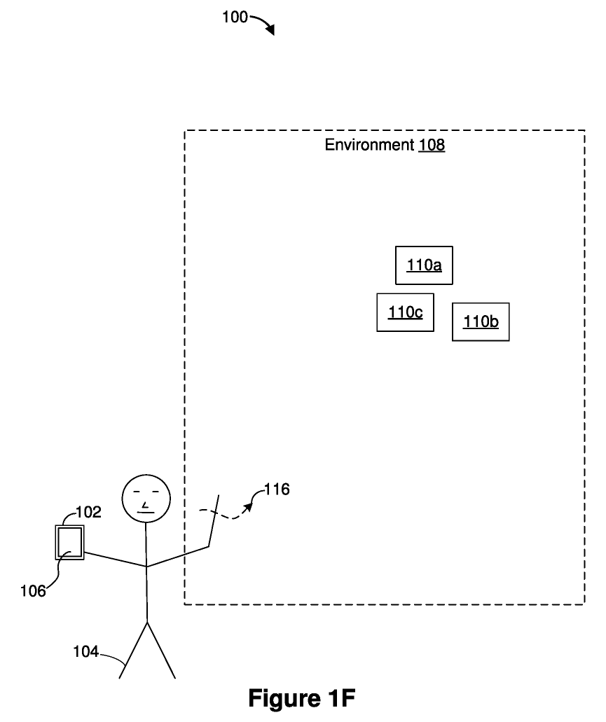

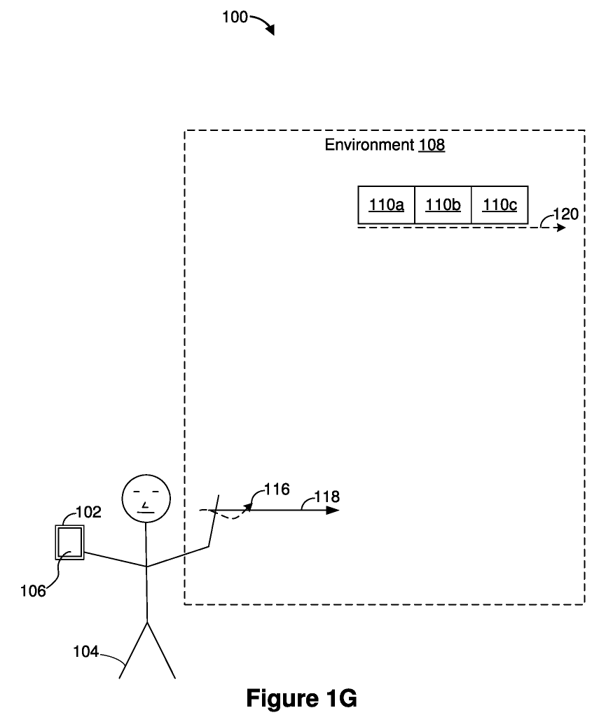

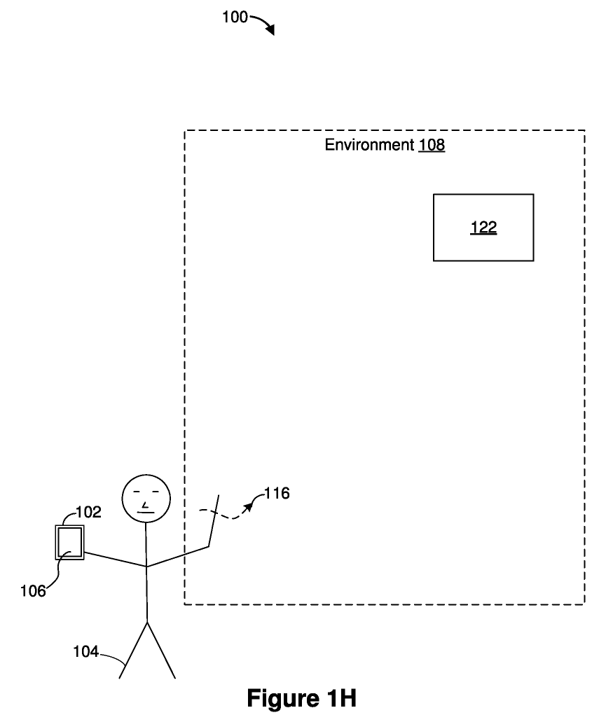

FIG. 1A is a diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes an electronic device 102 and a user 104.

In some implementations, the electronic device 102 includes a handheld computing device that can be held by the user 104. For example, in some implementations, the electronic device 102 includes a smartphone, a tablet, a media player, a laptop, or the like. In some implementations, the electronic device 102 includes a desktop computer. In some implementations, the electronic device 102 includes a wearable computing device that can be worn by the user 104. For example, in some implementations, the electronic device 102 includes a head-mountable device (HMD), an electronic watch or a pair of headphones. In some implementations, the electronic device 102 is a dedicated virtual assistant device that includes a speaker for playing audio and a microphone for receiving verbal commands. In some implementations, the electronic device 102 includes a television or a set-top box that outputs video data to a television.

In various implementations, the electronic device 102 includes (e.g., implements) a user interface engine that displays a user interface on a display 106. In some implementations, the display 106 is integrated in the electronic device 102. In some implementations, the display 106 is implemented as a separate device from the electronic device 102. For example, the display 106 may be implemented as an HMD that is in communication with the electronic device 102. In some implementations, the user interface engine displays the user interface in an extended reality (XR) environment 108 on the display 106. The user interface may include one or more virtual objects 110a, 110b, 110c (collectively referred to as virtual objects 110) that are displayed the XR environment 108.

As represented in FIG. 1B, the user 104 selects the virtual object 110a. In some implementations, the user 104 performs a first gesture 112 associated with the virtual object 110a. The appearance of the virtual object 110a may change to indicate that the virtual object 110a has been selected. For example, the electronic device 102 may display a visual effect 114, such as shimmering or deformation, associated with the virtual object 110a in response to receiving the first gesture 112. In some implementations, the electronic device 102 may generate an audio output and/or a haptic output in response to receiving the first gesture 112 to confirm selection of the virtual object 110a.

As represented in FIG. 1C, a movement 115 of the virtual object 110a may be displayed in the XR environment 108. For example, the user 104 may use gestures to move the virtual object 110a from a first position to a second position, as indicated by the solid arrow in FIG. 1C. In some implementations, the displayed movement is based on the first gesture 112. For example, the displayed movement may follow a direction of the first gesture 112. In some implementations, the electronic device 102 detects a movement of the virtual object 110a within a threshold distance of another virtual object. For example, the electronic device 102 may detect that the virtual object 110a has moved within a threshold distance d of the virtual object 110b, as indicated by the dashed double-ended arrow in FIG. 1C. It will be appreciated that the arrows illustrated in FIG. 1C are depicted for explanatory purposes only and may not be displayed in the XR environment 108.

In some implementations, as represented in FIG. 1D, when the electronic device 102 detects that the virtual object 110a has moved within the threshold distance d of the virtual object 110b, the electronic device 102 displays a movement 117 of the virtual object 110a and the virtual object 110b concurrently in the XR environment. In some implementations, the threshold distance d is greater than zero thereby reducing the need for the virtual object 110a to touch the virtual object 110b in order for the virtual objects 110a and 110b to move concurrently as a group. In some implementations, a non-zero threshold distance d allows multiple virtual objects to be grouped and moved together as a group while maintaining some spatial separation between the virtual objects. The displayed movement may be based on the first gesture 112. For example, the displayed movement may follow a direction of the first gesture 112. As represented in FIG. 1D, a concurrent movement of the virtual object 110a and the virtual object 110b within a threshold distance d of the virtual object 110c may be displayed.

As represented in FIG. 1E, when the electronic device 102 detects that the virtual objects 110a and 110b have moved within the threshold distance d of the virtual object 110c, the electronic device 102 may display a concurrent movement 119 of the virtual objects 110a, 110b, and 110c. As represented in FIG. 1F, in some implementations, the electronic device 102 detects a second gesture 116 performed by the user. In response to detecting the second gesture 116, the electronic device 102 may display the virtual objects 110a, 110b, and 110c at a location associated with the second gesture 116, e.g., a location in the XR environment 108 corresponding to an ending point of the second gesture 116 in a physical environment of the user 104. In some implementations, as represented in FIG. 1G, the second gesture 116 may follow a path 118 in the physical environment, and the virtual objects 110a, 110b, and 110c may be displayed along or near a path 120 in the XR environment 108 that corresponds to the path 118. In some implementations, as represented in FIG. 1H, the electronic device 102 creates a group including the virtual objects 110a, 110b, and 110c in response to detecting the second gesture 116. The group may be represented by a group object 122. The group object 122 may replace the individual virtual objects 110a, 110b, and 110c.

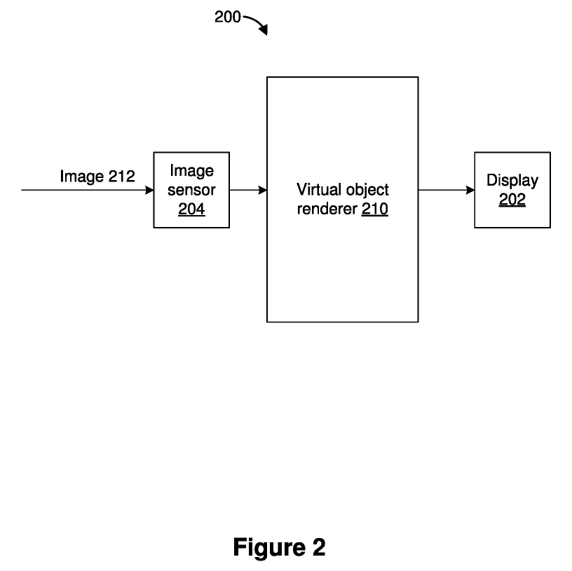

FIG. 2 is a block diagram of an example user interface engine 200. In some implementations, the user interface engine 200 resides at (e.g., is implemented by) the electronic device 102 shown in FIGS. 1A-1H. In various implementations, the user interface engine 200 facilitates selecting multiple virtual objects within an extended reality (XR) environment by allowing the user to use a first virtual object as a tool to accumulate other virtual objects and by displaying a concurrent movement of the accumulated virtual objects. The user interface engine 200 may include a display 202, one or more processors, an image sensor 204, and/or other input or control device(s).

While pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions and sub-functions implemented by the user interface engine 200 can be combined into one or more systems and/or further sub-divided into additional subsystems, and that the functionality described below is provided as merely one example configuration of the various aspects and functions described herein.

In some implementations, the user interface engine 200 includes a display 202. The display 202 displays one or more virtual objects, e.g., the virtual objects 110, in an XR environment, such as the XR environment 108 of FIGS. 1A-1H. A virtual object renderer 210 may receive a first gesture that is associated with a first virtual object in the XR environment. For example, the image sensor 204 may receive an image 212. The image 212 may be a still image or a video feed that comprises a series of image frames. The image 212 may include a set of pixels representing an extremity of the user. The virtual object renderer 210 may perform image analysis on the image 212 to detect a first gesture performed by a user. The first gesture may include, for example, a pinching gesture that is performed near the first virtual object.

In some implementations, the virtual object renderer 210 displays a movement of the first virtual object in the XR environment. For example, the virtual object renderer 210 may display a movement of the first virtual object to follow a gesture (e.g., a dragging gesture) performed by the user. In some implementations, the virtual object renderer 210 detects a movement of the first virtual object within a threshold distance of a second virtual object in the XR environment. For example, the virtual object renderer 210 may determine that the user has dragged the first virtual object within the threshold distance of the second virtual object. In response to detecting the movement of the first virtual object within the threshold distance of the second virtual object, the virtual object renderer 210 may display a movement of the first virtual object and the second virtual object concurrently in the XR environment. In some implementations, the movement is concurrent and is based on the first gesture. For example, the displayed movement may follow a direction of the first gesture.

In some implementations, this displayed concurrent movement of virtual objects is applied to larger groups of virtual objects. For example, if the virtual object renderer 210 determines that the user has dragged the first virtual object near multiple virtual objects in succession, a group of virtual objects (e.g., the group object 122 of FIG. 1H) may be formed. The group of virtual objects may include the virtual objects to which the first virtual object was displayed within a threshold distance. In this way, virtual objects may be accumulated. Concurrent movement of the virtual objects forming the group of virtual objects may be displayed.

In some implementations, if the virtual object renderer 210 receives a second gesture, the virtual object renderer 210 causes the display 202 to display the virtual objects at a location associated with the second gesture. For example, if the second gesture is a spreading of the user’s fingers, the virtual objects may be displayed proximate a location in the XR environment at which the user’s fingers were spread. In some implementations, the second gesture may follow a path. For example, the user may perform a finger spreading gesture while moving the hand in an arc. The virtual objects in the group may be displayed along or near the path. In some implementations, the virtual object renderer 210 may generate a group object. For example, the individual virtual objects may be replaced by the group object in the XR environment.

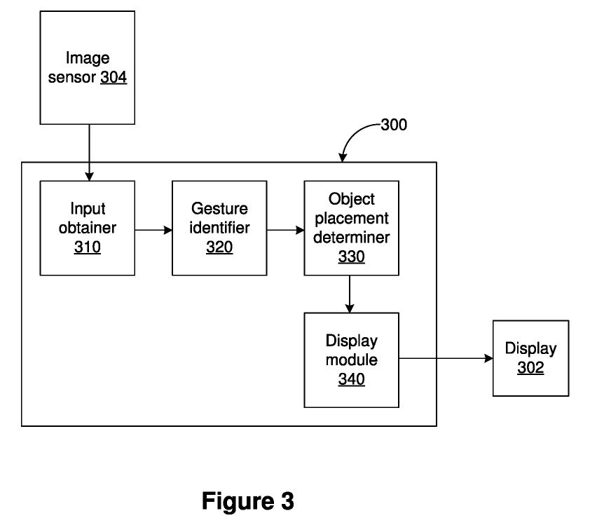

FIG. 3 is a block diagram of an example virtual object renderer 300 according to some implementations. In various implementations, the virtual object renderer 300 facilitates selecting multiple virtual objects within an extended reality (XR) environment by allowing the user to use a first virtual object to select other virtual objects and by displaying a movement of the selected virtual objects concurrently in the XR environment. In some implementations, the virtual object renderer 300 implements the virtual object renderer 210 shown in FIG. 2. In some implementations, the virtual object renderer 300 resides at (e.g., is implemented by) the electronic device 102 shown in FIGS. 1A-1H. The virtual object renderer 300 may include a display 302, one or more processors, an image sensor 304, and/or other input or control device(s).

While pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions and sub-functions implemented by the virtual object renderer 300 can be combined into one or more systems and/or further sub-divided into additional subsystems; and that the functionality described below is provided as merely one example configuration of the various aspects and functions described herein.

In some implementations, the display 302 displays a user interface in an XR environment. The user interface may include one or more virtual objects that are displayed in the XR environment. In some implementations, an input obtainer 310 receives a first gesture that is associated with a first virtual object in the XR environment. For example, the image sensor 304 may receive an image. The image may be a still image or a video feed that comprises a series of image frames. The image may include a set of pixels representing an extremity of the user.

In some implementations, a gesture identifier 320 performs image analysis on the image to detect a first gesture performed by the user. The first gesture may include, for example, a pinching gesture that is performed near the first virtual object. The gesture identifier 320 may identify the virtual object (e.g., the first virtual object) to which the gesture is directed. In some implementations, the gesture identifier 320 identifies a motion associated with the gesture. For example, if the user performs the first gesture along a path in the physical environment, the gesture identifier 320 may identify the path and/or determine a corresponding path in the XR environment.

In some implementations, an object placement determiner 330 determines a placement location of the first virtual object based on the first gesture. For example, if the user performs the first gesture along a path in the physical environment, the object placement determiner 330 may determine that the first virtual object should follow the corresponding path in the XR environment. In some implementations, the object placement determiner 330 determines the path in the XR environment that corresponds to the path of the first gesture in the physical environment. In some implementations, the gesture identifier 320 determines the corresponding path in the XR environment.

The object placement determiner 330 may detect a movement of the first virtual object in the XR environment within a threshold distance of a second virtual object in the XR environment. For example, the object placement determiner 330 may store and/or access location information (e.g., coordinates) associated with virtual objects in the XR environment. If the location information associated with the first virtual object and the location information associated with the second virtual object indicate that the distance between the first virtual object and the second virtual object is less than the threshold distance, the object placement determiner 330 may determine that the first virtual object has moved within the threshold distance of the second virtual object.

In some implementations, when the object placement determiner 330 determines that the first virtual object has moved within the threshold distance of the second virtual object, the object placement determiner 330 associates the first virtual object and the second virtual object, e.g., creates a group comprising the first virtual object and the second virtual object.

In some implementations, a display module 340 causes the display 302 to display virtual objects (e.g., the first virtual object and the second virtual object) at the object placement locations determined by the object placement determiner 330. Virtual objects that are associated with one another by the object placement determiner 330 may be displayed as a group. For example, if the object placement determiner 330 detects that the first virtual object has moved within the threshold distance of the second virtual object, the display module 340 may display a movement of the first virtual object and the second virtual object concurrently in the XR environment. The movement may be based on the first gesture. For example, if the first gesture follows a path in the physical environment, the displayed movement may follow a corresponding path in the XR environment.

In some implementations, the display module 340 displays concurrent movement of larger groups of virtual objects. For example, the object placement determiner 330 may determine that the user has dragged the first virtual object near multiple virtual objects in succession, e.g., if the distance between the first virtual object and other virtual objects in the XR environment is less than the threshold distance at various times over the course of the movement of the first virtual object. The object placement determiner 330 may create a group of multiple virtual objects that includes the virtual objects to which the first virtual object was displayed within a threshold distance. In this way, virtual objects may be accumulated. The display module 340 may cause the display 302 to display concurrent movement of the virtual objects forming the group of virtual objects.

In some implementations, if the gesture identifier 320 detects a second gesture, the display module 340 causes the display 302 to display the virtual objects at a location associated with the second gesture. For example, if the second gesture is a spreading of the user’s fingers, the virtual objects may be displayed proximate a location in the XR environment at which the user’s fingers were spread. In some implementations, the second gesture may follow a path in the physical environment. For example, the user may perform a finger spreading gesture while moving the hand in an arc. The virtual objects in the group may be displayed along or near a corresponding path in the XR environment. In some implementations, the object placement determiner 330 may generate a group object that replaces the individual virtual objects in the XR environment.

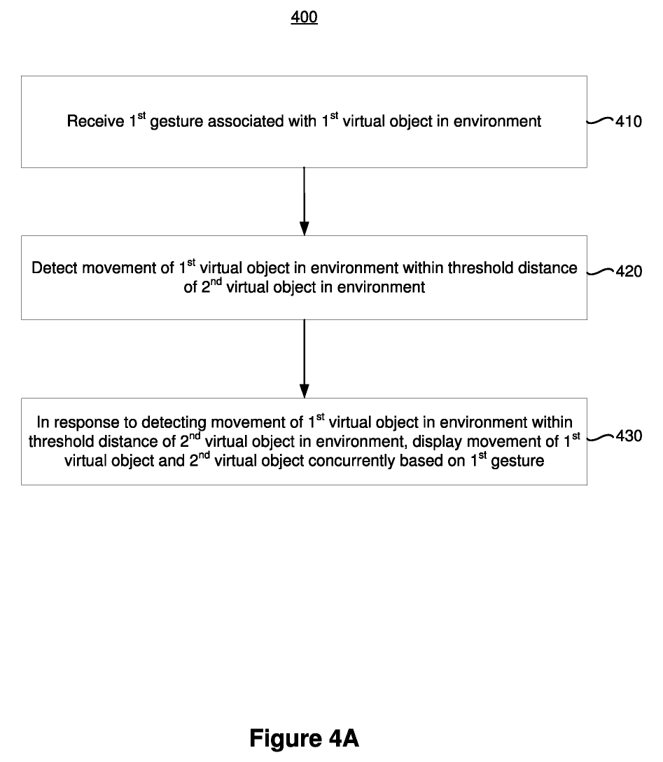

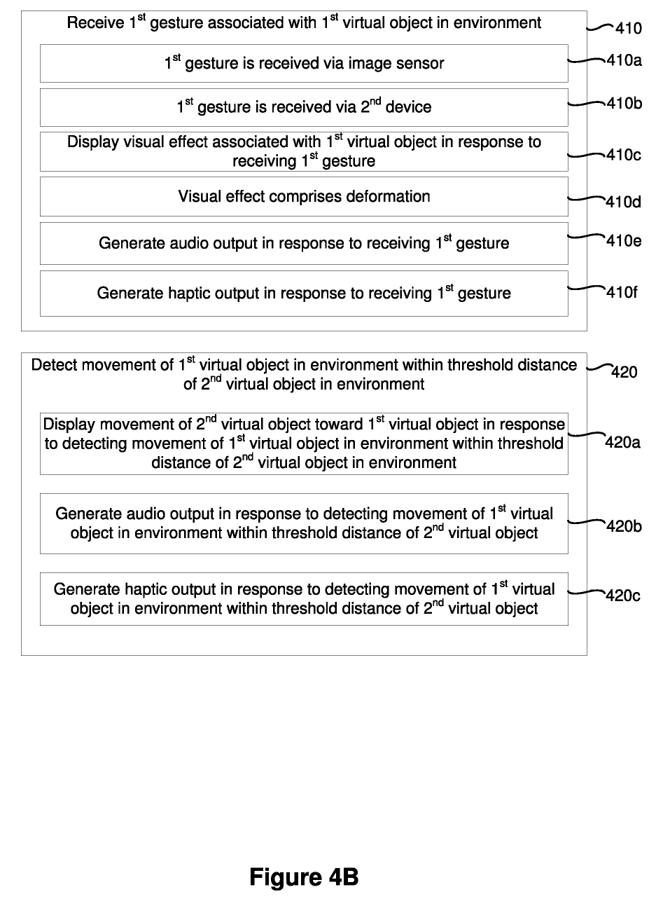

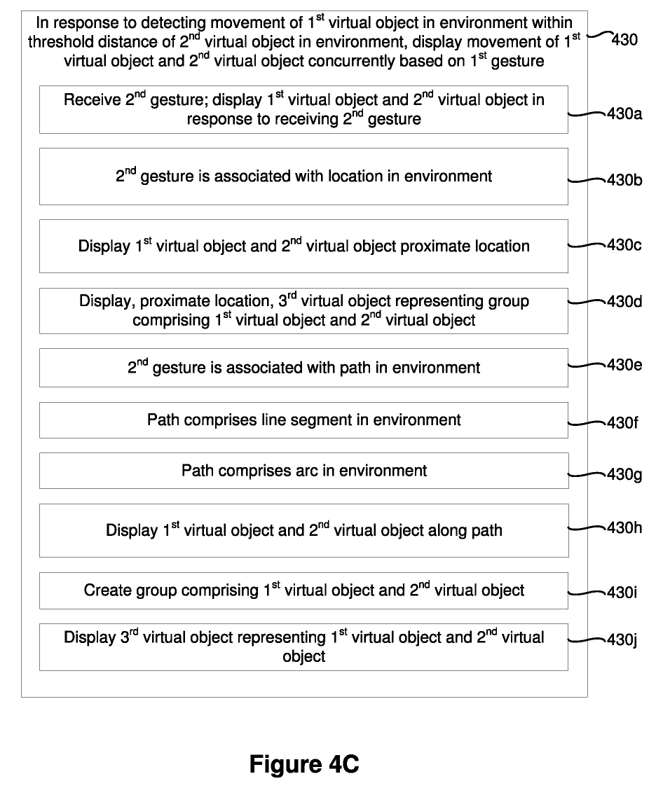

FIGS. 4A-4C are a flowchart representation of a method 400 for selecting multiple virtual objects within an extended reality (XR) environment in accordance with some implementations. In various implementations, the method 400 is performed by a device (e.g., the electronic device 102 shown in FIGS. 1A-1H). In some implementations, the method 400 is performed by processing logic, including hardware, firmware, software, or a combination thereof. In some implementations, the method 400 is performed by a processor executing code stored in a non-transitory computer-readable medium (e.g., a memory). Briefly, in various implementations, the method 400 includes receiving a first gesture associated with a first virtual object in an XR environment, detecting a movement of the first virtual object within a threshold distance of a second virtual object in the XR environment, and in response to detecting the movement, displaying a movement of the first virtual object and the second virtual object concurrently in the XR environment based on the first gesture.

In some implementations, a user interface including one or more virtual objects is displayed in an XR environment. A user may interact with a virtual object, e.g., using gestures, such as pinch and/or pull gestures, to manipulate the virtual object. Referring to FIG. 4A, as represented by block 410, in various implementations, the method 400 includes receiving a first gesture associated with a first virtual object in the XR environment. In some implementations, the first gesture initiates a group of virtual objects that includes the first virtual object. In some implementations, the first gesture corresponds to a request to create a new group of virtual objects and to include the first virtual object in the new group of virtual objects.

Referring to FIG. 4B, as represented by block 410a, the first gesture may be received via an image sensor. For example, the image sensor may receive an image. The image may be a still image or a video feed that comprises a series of image frames. The image may include a set of pixels representing an extremity of the user. Image analysis may be performed on the image to detect a first gesture performed by the user. The first gesture may include, for example, a pinching gesture that is performed near the first virtual object. The electronic device 102 may identify the virtual object (e.g., the first virtual object) to which the gesture is directed. In some implementations, the electronic device 102 identifies a motion associated with the gesture. For example, if the user performs the first gesture along a path in the physical environment, the electronic device 102 may identify the path. In some implementations, the electronic device 102 determines a corresponding path in the XR environment.

In some implementations, as represented by block 410b, the first gesture is received via a second device. For example, a wearable device may include an accelerometer, gyroscope, and/or inertial measurement unit (IMU) that may provide information relating to movements of an extremity of the user. As another example, the electronic device 102 may be implemented as a head-mountable device (HMD), and the first gesture may be received from a smartphone or tablet that is in communication with the electronic device 102.

In some implementations, as represented by block 410c, a visual effect is displayed in association with the first virtual object in response to receiving the first gesture. For example, to confirm selection of the first virtual object, a shimmering or other visual effect may be displayed. As represented by block 410d, the visual effect may include a deformation of the first virtual object. The deformation may be physics-based and may be dependent on a type of object represented by the virtual object. For example, the displayed deformation may be similar to a deformation of a real-world counterpart to the virtual object.

Other modalities for confirming selection of the first virtual object may be implemented. For example, as represented by block 410e, an audio output may be generated in response to receiving the first gesture. The audio output may include a sound effect and/or a verbal confirmation that the first virtual object was selected. In some implementations, as represented by block 410f, a haptic output is generated in response to receiving the first gesture. The haptic output may be delivered through the electronic device 102 and/or through another device.

In various implementations, as represented by block 420, the method 400 includes detecting a movement of the group of virtual objects including the first virtual object within the XR environment in a first direction towards a second virtual object in the XR environment. For example, the electronic device 102 may store and/or access location information (e.g., coordinates) associated with virtual objects in the XR environment. If the location information associated with the first virtual object and the location information associated with the second virtual object indicate that the distance between the first virtual object and the second virtual object is less than the threshold distance, the electronic device 102 may determine that the first virtual object has moved within the threshold distance of the second virtual object.

In some implementations, as represented by block 420a, the method 400 includes displaying a movement of the second virtual object toward the first virtual object in response to detecting the movement of the group of virtual objects including the first virtual object within the threshold distance of the second virtual object in the XR environment in order to indicate that the second virtual object has been included in the group of virtual objects. In some implementations, movement of the group of virtual objects including the first virtual object and the second virtual object may be displayed. This movement may be in respective directions toward a point between the first virtual object and the second virtual object.

In some implementations, as represented by block 420b, an audio output is generated in response to detecting the movement of the group of virtual objects including the first virtual object in the XR environment within the threshold distance of the second virtual object in the XR environment in order to indicate that the second virtual object has been included in the group of virtual objects. The audio output may include a sound effect and/or a verbal confirmation that the first virtual object and the second virtual object are associated with one another and/or have been added to the group of virtual objects, for example. In some implementations, as represented by block 420c, a haptic output is generated in response to detecting the movement of the group of virtual objects including the first virtual object in the XR environment within the threshold distance of the second virtual object in the XR environment in order to indicate that the second virtual object has been included in the group of virtual objects. The haptic output may be delivered through the electronic device 102 and/or through another device.

As represented by block 430, in some implementations, the method 400 includes, in response to detecting the movement of the group of virtual objects including the first virtual object in the environment within a threshold distance of the second virtual object in the environment, selecting the second virtual object for inclusion in the group of virtual objects and displaying a movement of the group of virtual objects including the first virtual object and the second virtual object in the environment based on the first gesture in a second direction that is different from the first direction. For example, as shown in FIG. 1C, when the virtual object 110a is moved within the threshold distance d of the virtual object 110b, the virtual object 110b and the virtual object 110a are grouped together into a group of virtual objects that moves together.

Referring to FIG. 4C, in some implementations, as represented by block 430a, the method 400 includes receiving a second gesture and displaying the group of virtual objects including the first virtual object and the second virtual object in response to receiving the second gesture. For example, the electronic device 102 may detect a finger spreading gesture performed by the user and may display the group of virtual objects including the first virtual object and the second virtual object when the finger spreading gesture is detected. In some implementations, as represented by block 430b, the second gesture is associated with a location in the XR environment. For example, the finger spreading gesture may be performed at a particular location in the XR environment. As represented by block 430c, the group of virtual objects including the first virtual object and the second virtual object may be displayed proximate the location with which the second gesture is associated. In some implementations, as represented by block 430d, a third virtual object may be displayed proximate the location with which the second gesture is associated. The third virtual object may represent the group of virtual objects that comprises the first virtual object and the second virtual object. For example, the third virtual object may be a virtual folder that replaces the first virtual object and the second virtual object. When the user interacts with the virtual folder, the first virtual object and the second virtual object may be displayed.

In some implementations, as represented by block 430e, the second gesture is associated with a path in the XR environment. For example, the user may trace a path in the physical environment while performing the second gesture. The path in the physical environment may correspond to a path in the XR environment. As represented by block 430f, the path may include a line segment in the XR environment. For example, the path in the physical environment may include a line segment that corresponds to a line segment in the XR environment. As represented by block 430g, the path may include an arc in the XR environment. For example, the path in the physical environment may include an arc that corresponds to an arc in the XR environment. In some implementations, the path may be a more complex shape, e.g., incorporating line segments and/or arcs. As represented by block 430h, the method 400 may include displaying the group of virtual objects including the first virtual object and the second virtual object along the path. For example, if the user traces a horizontal line in the physical environment while performing the second gesture, the group of virtual objects including the first virtual object and the second virtual object may be “dropped” along the corresponding horizontal line in the XR environment.

In some implementations, as represented by block 430i, the method 400 includes creating a group of virtual objects that includes the first virtual object and the second virtual object. For example, when the electronic device 102 detects movement of the first virtual object within the threshold distance of the second virtual object, the electronic device 102 may associate the first virtual object and the second virtual object with one another. As the first virtual object is moved around the XR environment, other virtual objects that the first virtual object moves near may be added to the group of virtual objects. In some implementations, concurrent movement of all of the virtual objects in the group is displayed. In some implementations, as represented by block 430j, a third virtual object representing the first virtual object and the second virtual object is displayed. The third virtual object may represent and/or replace all of the virtual objects in the group.

In some implementations, the second direction is towards a third virtual object in the environment. In some implementations, the method 400 includes, in response to detecting the movement of the group of virtual objects including the first virtual object and the second virtual object in the environment within the threshold distance of the third virtual object in the environment, selecting the third virtual object for inclusion in the group of virtual objects and displaying a movement of the group of virtual objects including the first virtual object, the second virtual object and the third virtual object in the environment based on the first gesture in a third direction that is different from the second direction.

In some implementations, the second direction is towards a portion of the environment that corresponds to a drop zone where the group of virtual objects is to be placed. In some implementations, the method 400 includes, in response to detecting the movement of the group of virtual objects including the first virtual object and the second virtual object into the drop zone, placing the group of virtual objects including the first virtual object and the second virtual object in the drop zone.

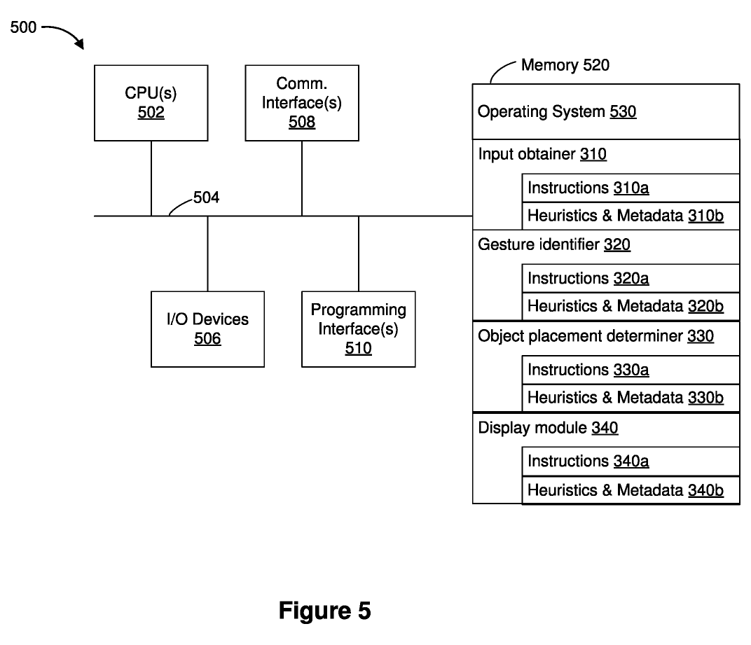

FIG. 5 is a block diagram of a device 500 enabled with one or more components of a device (e.g., the electronic device 102 shown in FIG. 1) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units (CPUs) 502, one or more input/output (I/O) devices 506 (e.g., an image sensor), one or more communication interface(s) 508, one or more programming interface(s) 510, a memory 520, and one or more communication buses 504 for interconnecting these and various other components.

In some implementations, the communication interface 508 is provided to, among other uses, establish, and maintain a metadata tunnel between a cloud-hosted network management system and at least one private network including one or more compliant devices. In some implementations, the one or more communication buses 504 include circuitry that interconnects and controls communications between system components. The memory 520 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 520 optionally includes one or more storage devices remotely located from the one or more CPUs 502. The memory 520 comprises a non-transitory computer readable storage medium.

In some implementations, the memory 520 or the non-transitory computer readable storage medium of the memory 520 stores the following programs, modules and data structures, or a subset thereof including an optional operating system 530, the input obtainer 310, the gesture identifier 320, the object placement determiner 330, and the display module 340. As described herein, the input obtainer 310 may include instructions 310a and/or heuristics and metadata 310b for receiving a first gesture that is associated with a first virtual object in the XR environment. As described herein, the gesture identifier 320 may include instructions 320a and/or heuristics and metadata 320b for performing image analysis on the image to detect the first gesture performed by the user. As described herein, the object placement determiner 330 may include instructions 330a and/or heuristics and metadata 330b for determining a placement location of the first virtual object based on the first gesture. As described herein, the display module 340 may include instructions 340a and/or heuristics and metadata 340b for causing a display to display virtual objects at the object placement locations determined by the object placement determiner 330.

It will be appreciated that FIG. 5 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 5 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

It will be appreciated that the figures are intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in the figures could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, one or more processors, and a non-transitory memory:
receiving a pinch gesture directed to a first virtual object in an environment;
after receiving the pinch gesture and before receiving a spread gesture, receiving a first drag gesture moving the first virtual object in a first direction towards a second virtual object in the environment;
while receiving the first drag gesture, in response to detecting the first virtual object within a threshold distance of the second virtual object, generating a group of virtual objects including the first virtual object and the second virtual object;
after receiving the first drag gesture and before receiving the spread gesture, receiving a second drag gesture moving the group of virtual objects in a second direction that is different from the first direction; and
after receiving the second drag gesture, receiving the spread gesture.

2. The method of claim 1, wherein the pinch gesture is received via an image sensor.

3. The method of claim 1, wherein the pinch gesture is received by performing image analysis on an image of a user’s hand.

4. The method of claim 1, further comprising, in response to receiving the pinch gesture, displaying a visual effect associated with the first virtual object.

5. The method of claim 1, further comprising, in response to receiving the pinch gesture, generating an audio output.

6. The method of claim 1, further comprising, in response to receiving the pinch gesture, generating a haptic output.

7. The method of claim 1, wherein the threshold distance is greater than zero.

8. The method of claim 1, further comprising, in response to generating the group of virtual objects, generating an audio output.

9. The method of claim 1, further comprising, in response to generating the group of virtual objects, generating a haptic output.

10. The method of claim 1, wherein the second drag gesture follows a path and the group of virtual objects is displayed along the path.

11. The method of claim 1, further comprising:
while receiving the second drag gesture, in response to detecting the group of virtual objects within a threshold distance of a third virtual object, adding the third virtual object to the group of virtual objects; and
after receiving the second drag gesture and before receiving the spread gesture, receiving a third drag gesture moving the group of virtual objects in a third direction that is different from the second direction.

12. The method of claim 1, further comprising displaying the group of virtual objects at a location of the spread gesture.

13. The method of claim 1, further comprising, in response to detecting the spread gesture, replacing the group of virtual objects with a group virtual object.

14. The method of claim 13, further comprising displaying the group of virtual objects in response to user interaction with the group virtual object.

15. A device comprising:
a display;
a non-transitory memory; and
one or more processors to:
receive a pinch gesture directed to a first virtual object in an environment;
after receiving the pinch gesture and before receiving a spread gesture, receive a first drag gesture moving the first virtual object in a first direction towards a second virtual object in the environment;
while receiving the first drag gesture, in response to detecting the first virtual object within a threshold distance of the second virtual object, generate a group of virtual objects including the first virtual object and the second virtual object;
after receiving the first drag gesture and before receiving the spread gesture, receive a second drag gesture moving the group of virtual objects in a second direction that is different from the first direction; and
after receiving the second drag gesture, receive the spread gesture.

16. The device of claim 15, wherein the one or more processors are further to, in response to generating the group of virtual objects, generate an audio output.

17. The device of claim 15, wherein the one or more processors are further to, in response to generating the group of virtual objects, generate a haptic output.

18. The device of claim 15, wherein the one or more processors are further to:
while receiving the second drag gesture, in response to detecting the group of virtual objects within a threshold distance of a third virtual object, add the third virtual object to the group of virtual objects; and
after receiving the second drag gesture and before receiving the spread gesture, receive a third drag gesture moving the group of virtual objects in a third direction that is different from the second direction.

19. The device of claim 15, wherein the one or more processors are further to, in response to detecting the spread gesture, replace the group of virtual objects with a group virtual object.

20. A non-transitory memory storing one or more programs, which, when executed by one or more processors of a device, cause the device to:
receive a pinch gesture directed to a first virtual object in an environment;
after receiving the pinch gesture and before receiving a spread gesture, receive a first drag gesture moving the first virtual object in a first direction towards a second virtual object in the environment;
while receiving the first drag gesture, in response to detecting the first virtual object within a threshold distance of the second virtual object, generate a group of virtual objects including the first virtual object and the second virtual object;
after receiving the first drag gesture and before receiving the spread gesture, receive a second drag gesture moving the group of virtual objects in a second direction that is different from the first direction; and
after receiving the second drag gesture, receive the spread gesture.
